(19) United States
(12) Patent Application Publication
(10) Pub. No.: US 2017/0197124 A1
(43) Pub. Date: Jul. 13, 2017

(54) SYSTEM AND APPARATUS FOR CLEANING A GOLF CLUB

(71) Applicant: Anthony Perrone, New Hyde Park, NY (US)

(72) Inventor: Anthony Perrone, New Hyde Park, NY (US)

(21) Appl. No.: 15/241,870

(22) Filed: Aug. 19, 2016

Related U.S. Application Data
(60) Provisional application No. 62/276,271, filed on Jan. 8, 2016.

(51) Int. Cl. A63B 57/60; B08B 3/04; B08B 1/00

(52) U.S. Cl. CPC A63B 57/60; B08B 1/002; B08B 3/04

(57) ABSTRACT

A golf club cleaning system is provided. The golf club cleaning system may include a golf club and a brush assembly. The brush assembly may include one or more brushes and one or more compartments in a housing. The brushes may be dipped into a cleaning liquid while the golf club is moved up and down in contact with the cleaning liquid to create a constant rubbing against the brushes.

### CROSS-REFERENCES TO RELATED APPLICATIONS

The present application claims the benefit of U.S. Provisional Application No. 62/276,271, entitled “Club Cleaner,” filed on Jan. 8, 2016, which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of cleaning apparatuses and, more specifically, to a portable golf club head cleaner that is operated using brushes.

### DESCRIPTION OF THE RELATED ART

In recent years, there has been a substantial increase in participation in leisure sporting activities such as golf. Golf has proved to be a popular pastime with an increasing number of participants taking up the game. While playing the game, the golf club head often becomes embedded with dirt, sand, and other foreign materials. These materials can clog the grooves cut into the face of the golf club head and can prevent proper contact between the club head and the golf ball. Furthermore, as the golf club head is generally precision balanced for optimum hitting force, these foreign materials are an impediment to optimal play of the game.

A typical golf club comprises of a head having a ball-striking face, a shaft connected at one end to the head, and a grip connected to the other end of the shaft for gripping and swinging the club. As a golfer proceeds across a golf course during a game, the golf club head tends to accumulate dirt and other debris on its ball-striking face from continued contact with the golf ball and ground. The accumulated dirt and debris can reduce a golfer's ability to accurately strike and move a ball in the intended manner. Therefore, it is desirable to periodically clean the ball-striking face of the club head, particularly before and during a golf game.

The ball-striking face of a golf club head typically defines a plurality of parallel grooves spaced relative to each other for affecting and/or controlling ball spin. Dirt and other debris become lodged in the grooves, and cannot be easily removed without scraping within the groove. Although a specialized tool, such as a multi-pronged scraper, may be able to clean the grooves, such tools are typically not effective for cleaning the entire ball-striking face.

Frequently, participants carry a cloth or other items to wipe the club head clean after it becomes clogged with foreign materials. As well, at times a golf tee is used to scrape out foreign material stuck in the grooves of the face of the golf club head. These cleaning methods are not usually satisfactory in cleaning the club head. The cloth soon becomes soiled from repeated use and cannot then be used. The hands of the participant also may become dirty through these cleaning methods. Furthermore, none of these cleaning methods provide a water source to assist in the cleaning process.

Most devices for cleaning golf club heads are relatively complex and include many mechanical and/or electrical components. Each of the many components may wear out, rust or otherwise fail with repeated use. Furthermore, such devices typically cannot be easily repaired by the golfer using the device, but must instead be repaired by a specialist with knowledge of the device. An apparatus for cleaning a golf club head would desirably include a fewer number of components that are not very susceptible to wear, rust or failure.

Therefore, what is needed is an apparatus for cleaning a golf club which has few components that have little susceptibly to wear, rust or failure.

### SUMMARY

In an embodiment, a golf club cleaning system is provided. The golf club cleaning system may include a golf club and a brush assembly. The brush assembly may include one or more brushes and one or more compartments in a housing. The brushes may be dipped into a cleaning liquid while the golf club is moved up and down in contact with the cleaning liquid to create a constant rubbing against the brushes.

In another embodiment, an apparatus for cleaning an item is provided. The apparatus may include a brush assembly. The brush assembly may include one or more brushes and one or more compartments in a housing. The brushes may be dipped into a cleaning liquid while an object is moved up and down in contact with the cleaning liquid to create a constant rubbing against the brushes.

In yet another embodiment, a cleaning system is provided. The cleaning system may include a brush device. The brush device may include one or more brushes and one or more compartments in a housing. The brushes may be dipped into a cleaning liquid while an object is moved up and down in contact with the cleaning liquid to create a constant rubbing against the brushes

### BRIEF DESCRIPTION OF THE DRAWINGS

The present invention is described in detail below with reference to the attached drawing figures, which are incorporated by reference herein and wherein:

FIG. 1 is a block diagram illustrating an exemplary embodiment of the invention;

FIG. 2 is a block diagram illustrating another exemplary embodiment of the invention; and

FIG. 3 is a block diagram of the brushes component illustrating an exemplary embodiment of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

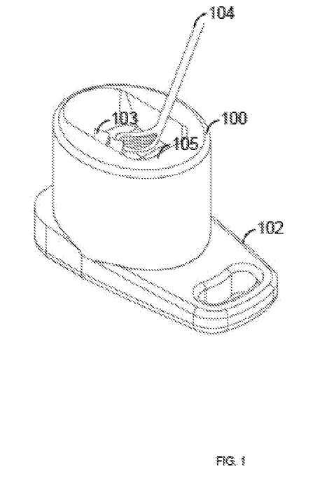

FIG. 1 illustrates a block diagram 100 in accordance with an exemplary embodiment of the invention. As shown in FIG. 1, the device 100 can has an outer body 102 with the brushes 103 installed for the operation of the effective cleaning of the clubs 104. The outer body 102 may be made of plastic or any material known by those skilled in the art. There will be a metal part (not shown) that may be used to secure the brushes 103 to the inner casing 105.

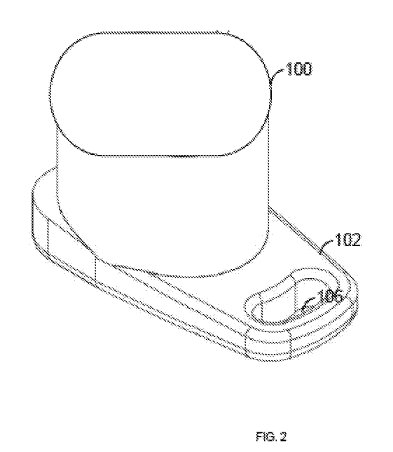

FIG. 2 illustrates a block diagram 100 in accordance with another exemplary embodiment of the invention. As shown in FIG. 2, the device 100 may be a portable device with an outer body 102 and a handle 106. Further, the device 100 may be a standalone device without with a golf club (not shown).

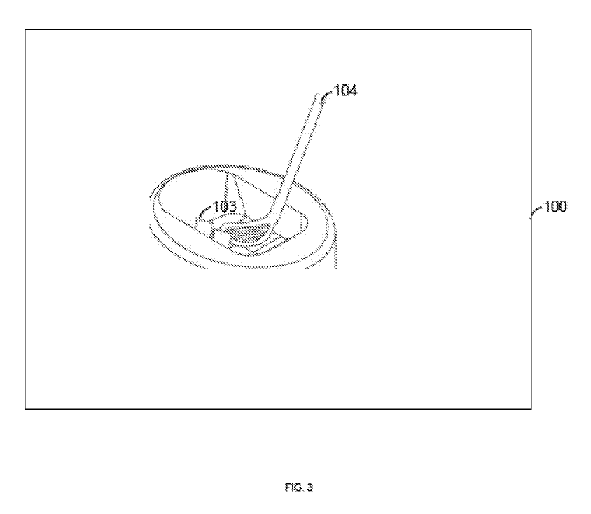

FIG. 3 illustrates a block diagram 100 in accordance with another exemplary embodiment of the invention. As shown in FIG. 3, brushes 103 may be arranged perpendicular to the axis in two halves. As a result, this arrangement may allow the brushes 103 to meet each other in the center. In some implementations, this arrangement may allow sufficient space to insert the club 104 into the device 100 to be cleaned.

In some implementations, the lower part of the device 100 is filled with a soap solution from the top. Leakage may be prevented by using a solid plastic top cover that will seal the device. The dimensions of the device 100 may include preferably 0-100 inches long by 0-100 inches high by 0-100 inches wide. The device 100 may be placed on the floor for the cleaning process while the user places one foot on the handle and moves their golf club 104 up and down until it is clean. The solution/soap and water may be filled from the top near the brushes. The up and down movement can be continued until the club 104 is noticeably cleaner. In some embodiments, there is a drainage port (not shown) on the lower rear end of the device 100 to empty the liquid when finished with use. The port may be water tight and able to open and close to release the liquids inside the device 100.

In an embodiment, the system may include a portable golf club washer which has two iron brush bristle sides. The washer may be rubber or any material known by those skilled in the art. The second golf iron brush and the first golf iron brush can be connected to end plates so that the second golf iron brush bristle side faces the first golf iron brush bristle side. A golf wood brush may include a bristle side. The golf wood brush may be connected to the second golf iron brush. In some implementations, the golf wood brush bristle side faces away from the second golf iron brush bristle side. A handle may be connected to the first golf iron brush.

In another embodiment, the system may include various washing apparatuses for golfers, such as a flexible container for containing washing liquid and for receiving objects to be washed therein, a handle connected to the container for manipulating the container, and a support mechanism for suspending the container and the handle from a golf bag and for restricting movement of the container. The container may include an opening through which objects such as golf club heads may be inserted, a closure for selectively sealing the opening, at least one flap extending away from the closure, a brush disposed within the container for scrubbing against objects inserted into the container during a washing operation, and a baffle for baffling movement of the washing liquid toward the opening after the liquid is placed in the container. The handle may be operatively connected to the container flap. The support mechanism may include a clip member for suspending the handle from a rim of a golf bag and which normally urges the container toward the golf bag when suspended there from to restrict movement of the container, while the support mechanism may optionally include a pouch in which said container is disposed and which operatively cooperates with the clip member to restrict movement of the container. When the pouch is used, the handle may also be connected to the pouch. The several components of the washing apparatus may be separable from each other for cleaning, storage, selective replacement, etc.

In still another embodiment, the apparatus may include a brush that has one or more bristles that are mounted on rotatable housing. Within the housing, there may be one or more lateral support surfaces spaced apart from each other that define a channel between them for receiving and retaining the golf club head. The bristles of the brush may define an arcuate path of movement extending along at least a portion of the channel. In some implementations, the bristles may engage the face of the club received within the channel. As the brush rotates, dirt and other debris may be removed from the face of the club. In some embodiments, a brush-engaging surface, such as a ledge, may project the arcuate path of the movement of the bristles. The brush-engaging surface may engage the bristles upon rotation of the brush. As a result, dirt and other debris may be dislodged from the bristles.

In yet another embodiment, the apparatus may include a container that has a bottom wall, a top edge, and a peripheral wall. The top edge may include an eyelet and an opening. A pair of resilient clamps may be attached to the top wall of the container. A brush member may be included that has an elongated handle and a head portion with a bristle arrangement. In some implementations, a ridge disk member may be integral to the handle and spaced from the handle end. Additionally, a ring seal may be positioned around the disk member.

In still another embodiment, the system may include a device that allows a manual repetitive up and down movement of the golf club against the bristles of a pair of cleansing brushes located at the top part of a housing with a cleansing liquid in the lower part of the housing and not in direct contact with the brushes.

In some embodiments, the apparatus may include a brush assembly contained in a housing including upper and lower compartments or sections. The upper section may contain one or more elongated brushes that are substantially parallel to the axis of an inserted shaft of a golf club that has a grip affixed to one end. The brushes may be dipped into a cleaning liquid while the club is moved up and down for contact with the soap solution to create a constant rubbing against the brushes.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A golf club cleaning system comprising:
a golf club; and
a brush assembly having one or more brushes and one or more compartments in a housing,
wherein the brushes are dipped into a cleaning liquid while the golf club is moved up and down in contact with the cleaning liquid to create a constant rubbing against the brushes.

2. The system of claim 1, wherein the brush assembly has an upper compartment.

3. The system of claim 1, wherein the brush assembly has a lower compartment.

4. The system of claim 1, wherein the system includes a container.

5. The system of claim 4, wherein the container includes a bottom wall, a top edge, and a peripheral wall.

6. The system of claim 1, wherein the brush assembly includes an elongated handle.

7. The system of claim 1, wherein the brush assembly includes a head portion with a bristle arrangement.

8. The system of claim 1, wherein the system includes a disk member.

9. An apparatus for cleaning an item comprising:
a brush assembly having one or more brushes and one or more compartments in a housing,
wherein the brushes are dipped into a cleaning liquid while an object is moved up and down in contact with the cleaning liquid to create a constant rubbing against the brushes.

10. The apparatus of claim 9, wherein the brush assembly has an upper compartment.

11. The apparatus of claim 9, wherein the brush assembly has a lower compartment.

12. The apparatus of claim 9, wherein the apparatus includes a container.

13. The apparatus of claim 12, wherein the container includes a bottom wall, a top edge, and a peripheral wall.

14. The apparatus of claim 9, wherein the brush assembly includes an elongated handle.

15. A cleaning system comprising:
a brush device having one or more brushes and one or more compartments in a housing,
wherein the brushes are dipped into a cleaning liquid while an object is moved up and down in contact with the cleaning liquid to create a constant rubbing against the brushes.

16. The system of claim 15, wherein the brush device has an upper compartment.

17. The system of claim 15, wherein the brush device has a lower compartment.

18. The system of claim 15, wherein the system includes a container.

19. The system of claim 18, wherein the container includes a bottom wall, a top edge, and a peripheral wall.

20. The system of claim 15, wherein the brush device includes an elongated handle.
